(19) United States
(12) Patent Application Publication
(10) Pub. No.: US 2009/0288293 A1
(43) Pub. Date: Nov. 26, 2009

(54) Metal core package substrate and method for manufacturing the same

(75) Inventors: Sang Youp Lee, Seoul (KR); Keung Jin Sohn, Seongnam-si (KR); Joung Gul Ryu, Seoul (KR); Jung Hwan Park, Seongnam-si (KR); Ho Sik Park, Hwaseong-si (KR); Jun Hyeong Park, Hwaseong-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/232,995

(22) Filed: Sep. 26, 2008

(30) Foreign Application Priority Data
May 21, 2008 (KR) 10-2008-0046868
Aug. 8, 2008 (KR) 10-2008-0077836

(51) Int. Cl. H01R 43/16

(52) U.S. Cl. 29/874

(57) ABSTRACT

A metal core package substrate and a method for manufacturing the same. A method for manufacturing a metal core package substrate may include: forming a plurality of holes in a metal core; forming a plurality of paste bumps piercing into insulation layers of a first copper foil layer and a second copper foil layer; positioning the first and second copper foil layers at positions corresponding to the holes of the metal core so that the paste bumps are opposed to each other around the metal core; allowing each paste bump to pierce into the holes of the metal core by pressing the first and second copper foil layers; and forming inner circuits in the metal core pierced with the paste bumps.

### CROSS-REFERENCE TO RELATED APPLICATIONS

This application claims the benefit of Korean Patent Application Nos. 10-2008-0046868 and 10-2008-0077836 filed with the Korea Intellectual Property Office on May 21, 2007 and Aug. 8, 2008, the disclosure of which is incorporated herein by reference.

### BACKGROUND OF THE INVENTION

1. Field of the Invention

The present invention relates to a meal core package substrate and a method for manufacturing the same; and more particularly, to a meal core package substrate and a method for manufacturing the same capable of simplifying an interlayer connection process by allowing a paste bump printed on a copper foil layer to penetrate a hole of a metal core.

2. Description of the Related Art

As electronic products undergo trends of a smaller size, a lighter weight, a higher speed, and a higher capacity, semiconductor package substrates are also requested to be thinner and have higher functionalities.

More particularly, in order to realize an MCP (Multi Chip Package) which is a technique of mounting a plurality of semiconductor chips with stacking the semiconductor chips on one substrate or a PoP (Package on Package) which is a technique of stacking a plurality of substrates mounted with the chips, the development of substrates having a thermal expansion behavior of a level similar to a chip and an excellent bending property after being mounted is required.

A technique of manufacturing a metal core substrate by inserting a metal into a core is used in order to respond to such requirements.

A general metal core substrate manufacturing technique is disclosed in a commonly owned Korea Patent Registration No. 0601476 entitled “Packaging Substrate Using Metal Core and Manufacturing Method Thereof”, which is incorporated herein by reference.

In the prior art, an IVH (Interstitial Via Hole) for metal core interlayer connection is formed by a drill (CNC or CO₂/YAG) technique, an inner circuit pattern is formed by etching a surface of a metal core, an oxidation layer is formed by oxidizing the surface of the metal core with the inner circuit pattern formed thereon, an inner circuit layer is formed by filling depressed portions of an oxidation layer, which correspond to the via hole and the inner circuit pattern with a conductive material, and a multi-layered outer circuit layer is formed on the inner circuit pattern by a build-up method.

Since the metal is excellent in a thermal expansion property and a bending property, the metal serves to suppress the thermal expansion behavior of the substrate and prevent the substrate from being bent. Since the meal has an excellent heat emission property, a problem of heat emission occurring at the time of actuating a package module can be solved.

However, there is a problem in processing the via hole through the conventional drill (CNC or CO₂/YAG) technique due to a metallic characteristic.

In order to solve the problem, there is used a technique of forming a hole larger than the hole to easily drill the hole by previously etching the metal with a dry film in the same manner as the circuit formation.

This prior art is carried out by the following steps.

First, copper is plated on the metal core itself or both surfaces of the metal core.

A land hole is formed in the metal core by exposing, developing, etching, and delaminating processes with the dry film for the drilling.

Subsequently, a copper foil laminated layer inserted with the metal core through a press is manufactured by using a copper foil of 3 μm or more and insulation materials (a prepreg, etc.).

After then, a desmear process is performed after the drilling for the interlayer connection, a plating process is performed through chemical copper and electrolytic copper, and the inner circuit is formed by a subtractive process, an SAP (Semi Additive Process), or an MSAP (Modified Semi Additive Process).

After the copper foil and the insulation materials are laid in an upper part and a lower part of a core layer, and are pressed, a metal core substrate of four layers or more is manufactured through via processing (PTH or BVH) and a build-up process of forming an outer layer circuit in the same manner as the inner circuit.

Subsequently, in order to protect a circuit of the substrate with the outer circuit formed thereon, a surface treatment is performed by using solder resist application and methods such as an OSP, an ENEPIG, and the like to prevent a pad part from being oxidized and corroded.

A solder ball is formed through a reflow process after printing a part of a main board or the package substrate by using solder paste and a bump is formed through a coining process.

However, in the prior art, since the drilling and plating should be performed for the interlayer connection of the metal core substrate, the package substrate has many holes to be processed for the interlayer connection. Therefore, since the prior art has many drilling steps and plating steps, the prior art has a demerit that process cost is high and a process time is long.

### SUMMARY OF THE INVENTION

An advantage of the present invention is that it provides a method for manufacturing a metal core package substrate capable of simplifying a process by allowing a paste bump to interlayer electrical connection by penetrating a hole of a metal core through a pressing process after laying the paste bump in a position corresponding to a hole while positioning a copper foil layer formed by penetrating the paste bump into an insulation layer on one surface or both surfaces of the metal core having the hole.

In accordance with an aspect of the present invention, there is provided a method for manufacturing a metal core package substrate including the steps of: forming a plurality of holes in a metal core; forming a plurality of paste bumps piercing into an insulation layer on a first copper foil layer; forming the insulation layer on a second copper foil layer; positioning the first copper foil layer so that the paste bumps are positioned at positions corresponding to the holes of the metal core on the metal core and positioning the insulation layer of the second copper foil layer to face the metal core; allowing each paste bump to pierce into the holes of the metal core by pressing the first copper foil layer and the second copper foil layer; and forming inner circuits in the metal core pierced with the paste bumps.

In accordance with another aspect of the present invention, there is provided a method for manufacturing a metal core package substrate including the steps of: forming a plurality of holes in a metal core; forming a plurality of paste bumps piercing into insulation layers of each of a first copper foil layer and a second copper foil layer; positioning the first and second copper foil layer at positions corresponding to the holes of the metal core so that the paste bumps are opposed to each other around the metal core; allowing each paste bump to pierce into the holes of the metal core by pressing the first and second copper foil layers; and forming inner circuits in the metal core pierced with the paste bumps.

In accordance with the aspects of the present invention, the method may include the step of forming multi-layered outer circuit layers in an upper part and a lower part of the inner circuit by a build-up method.

Widths and heights of the paste bumps may have 300 um or 300 nm or less.

The insulation layer may be made of any one selected from build-up materials such as epoxy based insulating materials (FR1 to FR5), an ABF (Ajinomoto Build-up Film), an LCP (Liquid Crystal Polymer), PTFE (PolyTetraFluoroEthylene), PI (PolyImide), and PEEK (PolyEtherEtherKeton).

A thickness of each copper foil layer is in the range of 1 to 35 μm.

A process of forming solder paste on the outer circuits may be further performed in order to protect the circuit. A surface treatment process and a process of forming a solder bump in a mounting portion are further performed after the solder paste forming process.

The surface treatment process is performed by any one selected from an electro gold plating method, an OSP (Organic Solderability Preservative) method, an immersion tin plating method, an ENIG (Electroless Nickel Immersion Gold) method, an ENEPIG (Electroless Nickel Electroless Palladium Immersion Gold) method, and the like.

In accordance with a further embodiment, a metal core package substrate includes a metal core layer including a plurality of holes penetrating a body; a paste bump penetrating the holes; first and second insulating layers exposing both end portions of the paste bump and disposed on both surface of the metal core layer; and circuits disposed on outer surfaces of the first and second insulating layers, and electrically connected to each other.

The both end portions of the paste bump may have different areas.

Widths of the both end portions of the paste bump may decrease toward the inside.

The metal core layer may include a metal core and plating layers disposed on both surfaces of the metal core.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A to 1I are sequential process cross-sectional views illustrating a method for manufacturing a metal core package substrate in accordance with a first embodiment of the present invention;

FIGS. 2A to 2H are sequential process cross-sectional views illustrating a method for manufacturing a metal core package substrate in accordance with a second embodiment of the present invention;

FIG. 3 is a cross-sectional view of a metal core package substrate according to a third embodiment of the present invention; and

FIG. 4 is a cross-sectional view of a metal core package substrate according to a fourth embodiment of the present invention.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

A metal core package substrate and a method for manufacturing the same, and advantages thereof in accordance with the present invention will be apparent and more readily appreciated from the following description of the embodiments, taken in conjunction with the accompanying drawings.

### First Embodiment

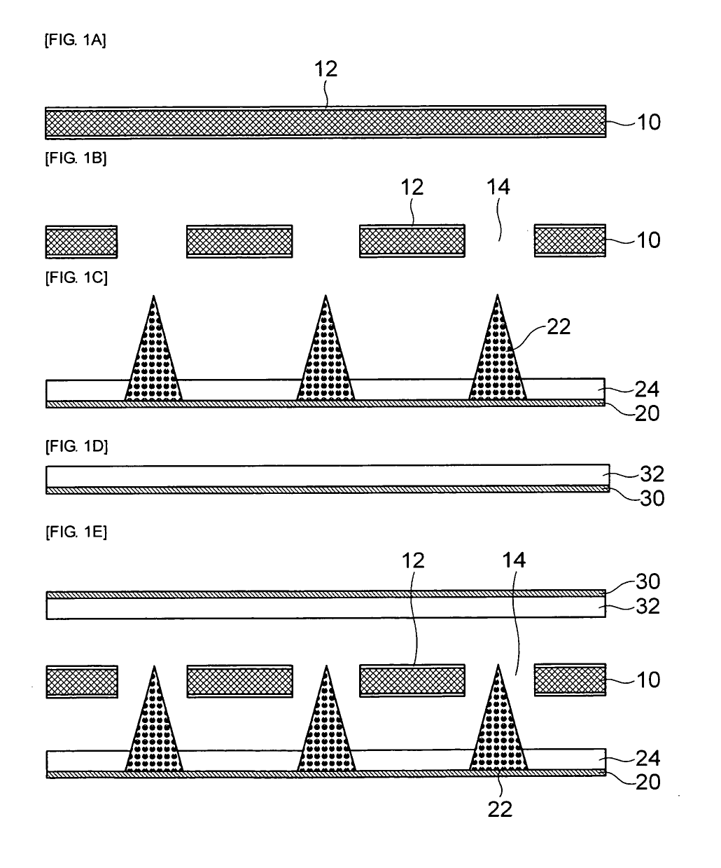

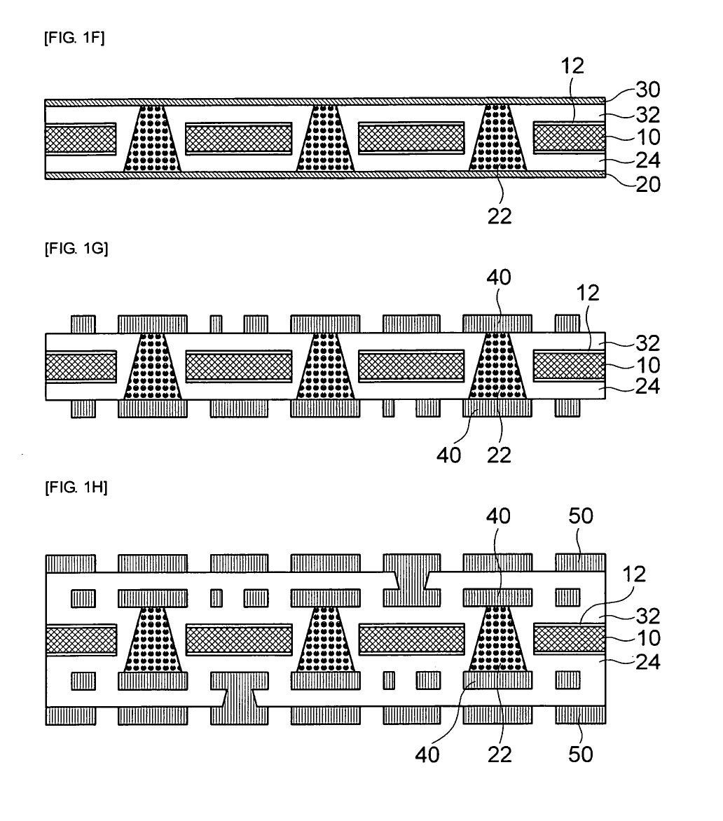

FIGS. 1A to 1I are sequential process cross-sectional views illustrating a method for manufacturing a metal core package substrate in accordance with a first embodiment of the present invention.

First, referring to FIG. 1A, a plate layer 12 of 10 μm or less is formed by performing a plating process for a metal core 10. At this time, in the first embodiment of the present invention, a forming process of the plate layer 12 is illustrated, but the plate layer forming process may be omitted.

Meanwhile, an oxidization layer (not shown) may be formed by using anodizing method in addition to the plate layer. At this time, in case of forming the oxidization layer, the metal core 10 can be electrically insulated and adhesive strength to an insulation layer for forming an inner circuit can be enhanced.

Referring to FIG. 1B, a plurality of land-shaped holes 14 for interlayer connection to the metal core 10 are formed. At this time, a method using a dry film and a drilling method or a punching method may be adopted as a method for forming the plurality of holes 14.

In case of using the dry film, although not specifically shown in the figure, the dry film is formed in the metal core 10 and parts where the holes 14 will be formed are defined by patterning through exposing and developing processes for the dry film, and the holes 14 of the metal core 10 are etched through an etching process using the patterned dry film as an etching mask, and a dry film delaminating process is performed, whereby the formation of the plurality of holes 14 is realized.

In case of using the drilling method, the formation of the holes 14 is performed by a CNC processing method, a CO₂ laser processing method, or YAG processing method.

Referring to FIG. 1C, a plurality of paste bumps 22 are formed by printing paste on a first copper foil layer 20 and drying the paste, and the paste bump 22 pierces into a first insulation layer 24 by forming the first insulation layer 24.

At this time, it is preferable to form the paste bump 22 by using conductive paste. A width of the paste bump 22 is approximately 300 μm or less. A desired height of the paste bump 22 can be secured by repetitively printing the first insulation layer 24 so that the paste bump 22 can be exposed on a top part of the first insulation layer 24 by approximately 10 to 50 μm after piercing into the first insulation layer 24 in order to secure high bonding reliability after stacking.

The first insulation layer 24 may be made of any one selected from build-up materials such as epoxy based insulating materials, an ABF (Ajinomoto Build-up Film), an LCP (Liquid Crystal Polymer), PTFE (PolyTetraFluoroEthylene), PI (PolyImide), and PEEK (PolyEtheretherketon) in addition to general prepreg.

Referring to FIG. 1D, an insulation layer 32 is formed on a second copper foil layer 30.

Referring to FIG. 1E, the first copper foil layer 20 and the second copper foil layer 30 are opposed to each other around the metal core 10.

At this time, the paste bump 22 is positioned at a position corresponding to the hole of the metal core 10 in the first copper foil layer 20 and the second insulation layer 32 faces the metal core 10 in the second copper foil layer 30.

Referring to FIG. 1F, the paste bump 22 pierces into the hole of the metal core 10 by pressing the first copper foil layer 20 and the second copper foil layer 30.

Referring to FIG. 1G, an inner circuit 40 is formed in an upper part and a lower part of the metal core 10 pierced with the paste bump 22.

At this time, the inner circuit 40 may be formed by a general circuit forming process such as a subtractive process or an SAP (Semi Additive Process).

Referring to FIG. 1H, a multi-layered outer circuit 50 is formed on the inner circuit 40 by the build-up method in the same manner as the forming process of the inner circuit 40.

Referring to FIG. 1I, a part of the outer circuit 50 is exposed by applying photo solder resist ink to the outer circuit 50 and developing the photo solder resist ink in order to protect the outer circuit 50.

A surface treatment layer 70 for a connection portion with an external printed circuit board (not shown) or an external electric element (not shown) or a solder bump 80 is formed for bonding with the external printed circuit board (not shown) or the external electric element (not shown).

At this time, the surface treatment layer 70 may be formed by methods such as electro gold plating using Ni/Au method, OSP (Organic Solderability Preservative) method, an immersion tin plating method, an ENIG (Electroless Nickel Immersion Gold) method, an ENEPIG (Electroless Nickel Electroless Palladium Immersion Gold) method, or the like.

### Second Embodiment

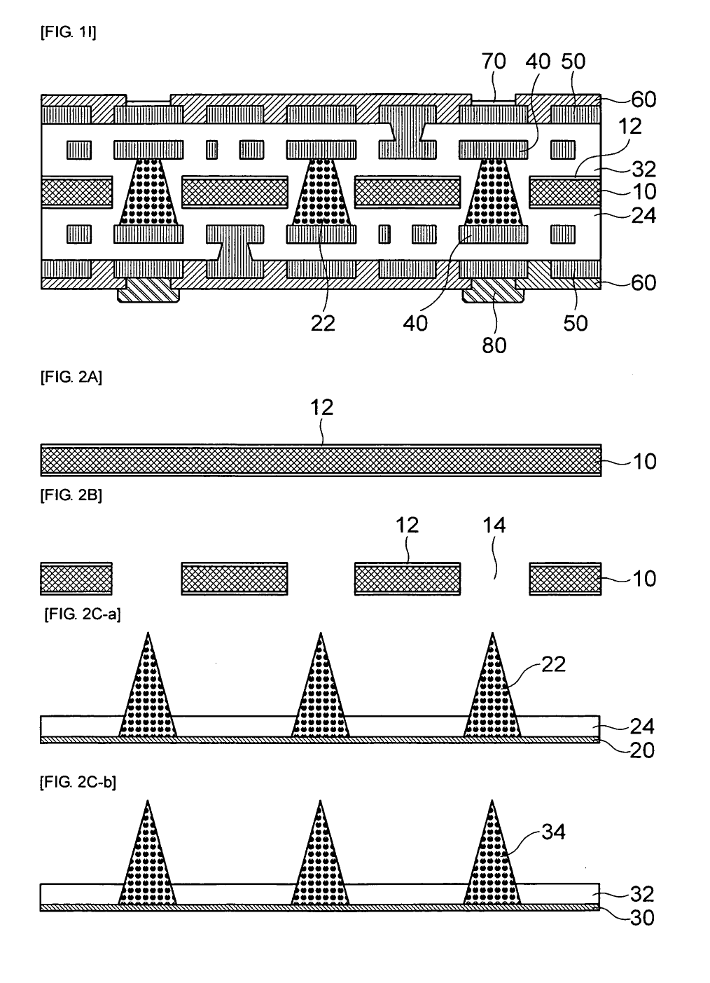

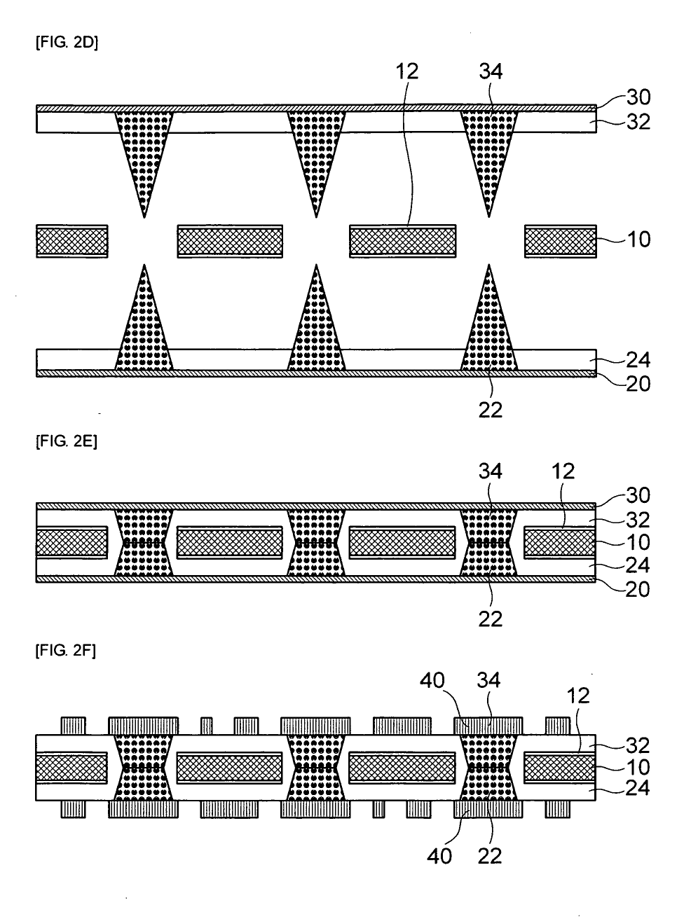

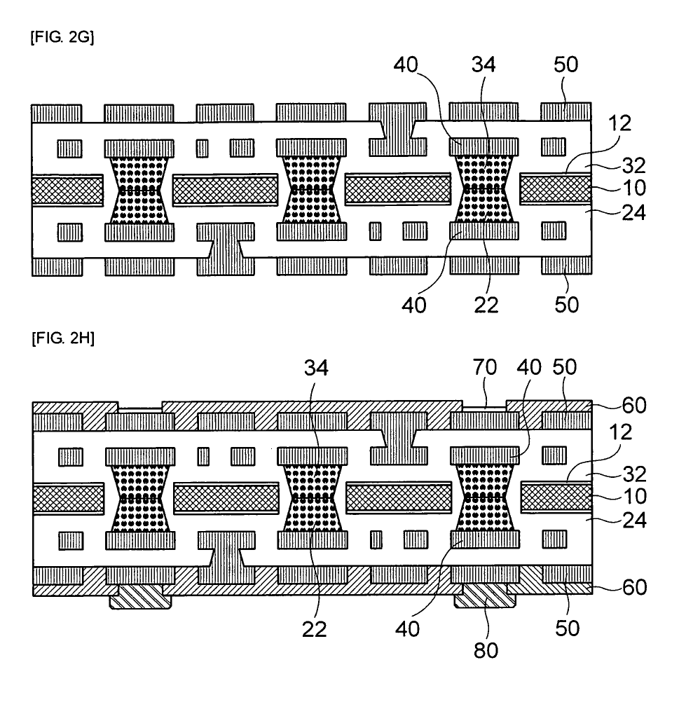

FIGS. 2A to 2H are sequential process cross-sectional views illustrating a method for manufacturing a metal core package substrate in accordance with a second embodiment of the present invention. Like reference numerals refer to like elements the same as the above-described first embodiment of the present invention.

First, referring to FIG. 2A, a plate layer 12 of 10 μm or less is formed by performing a plating process for a metal core 10. At this time, in the second embodiment of the present invention, a forming process of the plate layer 12 is illustrated, but the plate layer forming process may be omitted.

Referring to FIG. 2B, a plurality of land-shaped holes 14 for interlayer connection to the metal core 10 are formed. At this time, a method using a dry film and a drilling method or a punching method may be adopted as a method for forming the plurality of holes 14.

In case of using the dry film, although not specifically shown in the figure, the dry film is formed in the metal core 10 and parts where the holes 14 will be formed are defined by patterning through exposing and developing processes for the dry film, and the holes 14 of the metal core 10 are etched through an etching process using the patterned dry film as an etching mask, whereby the formation of the plurality of holes 14 is realized by a dry film delaminating process is realized.

In case of using the drilling method, the formation of the holes 14 is performed by a CNC processing method, a CO₂ laser processing method, or YAG processing method.

Referring to FIG. 2C-a, a plurality of paste bumps 22 are formed by printing paste on a first copper foil layer 20 and drying the paste, and a first insulation layer 24 is formed on the first copper foil layer 20, whereby the paste bump 22 pierces into the first insulation layer 24.

As shown in FIG. 2C-b, a paste bump 34 is formed on the second copper foil layer 30 and a second insulation layer 32 is formed on the second copper foil layer 30, whereby the paste bump 34 pierces into a second insulation layer 32.

At this time, widths of the paste bumps 22 and 34 are approximately 300 μm or less. Desired heights of the paste bumps 22 and 34 can be secured by repetitively printing the insulation layers 24 and 32 so that the paste bumps 22 and 34 can be exposed on top parts of the insulation layers 24 and 32 by approximately 10 to 50 μm after piercing into the insulation layers 24 and 32 in order to secure high bonding reliability after stacking.

The insulation layers 24 and 32 may be made of any one selected from a build-up materials such as epoxy based insulating materials, an ABF (Ajinomoto Build-up Film), an LCP (Liquid Crystal Polymer), PTFE (PolyTetraFluoroEthylene), PI (PolyImide), and PEEK (PolyEtheretherketon) in addition to general prepreg.

Referring to FIG. 2D, the first copper foil layer 20 and the second copper foil layer 30 are positioned so that the paste bumps 22 and 34 on the first copper foil layer 20 and the second copper foil layer 30 faces each other around the metal core 10.

Referring to FIG. 2E, the paste bump 22 on the first copper foil layer 20 and the paste bump 34 on the second copper foil layer 30 are electrically connected to each other so that the paste bumps 22 and 34 pierce into the holes of the metal core 10 by pressing the first copper foil layer 20 and the second copper foil layer 30.

Referring to FIG. 2F, inner circuits 40 are formed in an upper part and a lower part of the metal core 10.

At this time, the inner circuits 40 may be formed by a general circuit forming process such as a subtractive process or an SAP (Semi Additive Process).

Referring to FIG. 2G, multi-layered outer circuits 50 are formed on the inner circuits 40 by the build-up method in the same manner as the forming process of the inner circuits 40.

Referring to FIG. 2H, parts of the outer circuits 50 are exposed by applying photo solder resist ink to the outer circuits 50 and developing the photo solder resist ink in order to protect the outer circuits 50.

A surface treatment layer 70 for a connection portion with an external printed circuit board (not shown) or an external electric element (not shown) or a solder bump 80 is formed for bonding with the external printed circuit board (not shown) or the external electric element (not shown).

At this time, the surface treatment layer 70 may be formed by methods such as electro gold plating using Ni/Au, OSP (Organic Solderability Preservative), immersion tin plating, ENIG (Electroless Nickel Immersion Gold, ENEPIG (Electroless Nickel Electroless Palladium Immersion Gold), or the like.

Since there was a problem that process cost is high and a process time is long in the interlayer electrical connection through a drilling process and a plating process due to many holes to be processed for the interlayer connection in the prior art, but the interlayer connection can be achieved by bonding the paste bump to an inside of the hole of the metal core on the both surfaces of the metal core after printing the paste bump on the copper foil and allowing the paste bump to pierce into the insulation layer in the present invention.

As described above, in the present invention, it is possible to save manufacturing cost and shorten a manufacturing time by omitting the conventional drilling process and the plating process performed for the interlayer connection.

### Third Embodiment

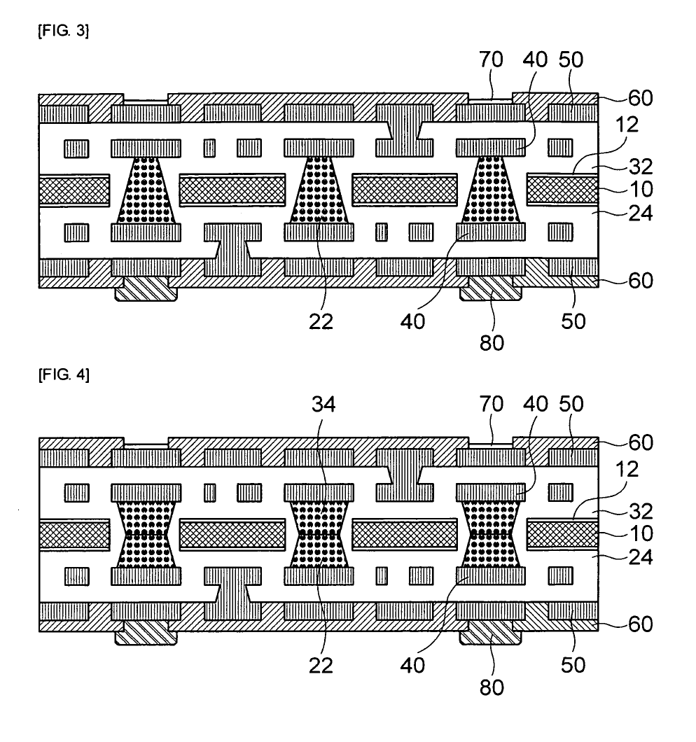

FIG. 3 is a cross-sectional view of a metal core package substrate according to a third embodiment of the present invention. Herein, in the third embodiment, the metal core package substrate manufactured according to the first embodiment will be described in detail.

Referring to FIG. 3, the metal core package substrate according to the embodiment of the present invention includes metal core layers 10 and 12, a paste bump 22, first and second insulating layers 24 and 32, and circuits 40 and 50.

The metal core layers 10 and 12 serve to prevent the completed metal core package substrate from a thermal expansion behavior and bending. The metal core layers include a metal core 10 made of metal and plating layers 12 disposed on both surfaces of the metal core 10. The metal core layers 10 and 12 include a plurality of holes for performing interlayer connection by penetrating the metal core 10 and the plating layers 12.

The paste bump 22 is disposed to penetrate the holes. At this time, both end portions of the paste bump 22 are exposed on the metal core layers 10 and 12. Herein, the paste bump 22 is made of a conductive material and thus has conductivity.

After the paste bump 22 is formed on the first insulating layer 24 described below, the paste bump 22 is inserted into the hole. Hence, the both end portions of the paste bump 22 may have different widths in order to easily insert the paste bump 22 into the hole. For example, an upper end portion of the paste bump 22 facing an insertion direction of the paste bump into the hole may have a width smaller than a lower end portion of the paste bump being in contact with the insulating layer 24.

The first and second insulating layers 24 and 32 are disposed on both surfaces of the metal core layers 10 and 12, respectively. At this time, the first and second insulating layers 24 and 32 allow the both end portions of the paste bump 22 to be exposed. Herein, the exposed both end portions of the paste bump 22 is in electrical connection with an inner circuit 40 disposed on an outer surface of each of the first and second insulating layers 24 and 32.

In addition, an outer circuit 50 is further disposed on the inner circuit 40, whereby the metal core package substrate may have a multi-layered circuit.

In order to protect the outer circuit 50, a photo solder resistor 60 may be disposed on the first and second insulating layers 24 and 32. At this time, the photo solder resistor 60 exposes a part of the outer circuit 50 to be in electrical connection with an external electric device (not shown).

A surface treatment layer 70 may be further disposed on the exposed outer circuit 50 or a solder bump may be further disposed on the exposed outer circuit 50 to connect the electric device with the outer circuit 60.

### Fourth Embodiment

FIG. 4 is a cross-sectional view of a metal core package substrate according to a fourth embodiment of the present invention. Herein, in the fourth embodiment, the metal core package substrate manufactured according to the second embodiment will be described in detail. Since the fourth embodiment has the same elements as the third embodiment, like reference numbers refer to like elements and the repeated description will be omitted.

Referring to FIG. 4, the metal core package substrate according to the embodiment of the present invention includes metal core layers 10 and 12, paste bumps 22 and 34, first and second insulating layers 24 and 32, and circuits 40 and 50.

The paste bumps 22 and 34 penetrate the metal core layers 10 and 12, and the first and second insulating layers 24 and 32, and electrically connect inner circuits 40 disposed on the first and second insulating layers 24 and 32 to each other.

After the paste bumps 22 and 34 are formed on the first and second insulating layers 24 and 32, respectively, the paste bump 22 formed on the first insulating layer 24 and the paste bump 34 formed on the second insulating layer 32 are inserted into a plurality of holes to be opposed to each other.

Herein, in order to easily insert the paste bumps 22 and 34 into the holes, one end portion of the paste bump 22 formed on the first insulating layer 24 and the one end portion of the paste bump 34 formed on the second insulating layer 32 may have widths smaller than the other ends of the paste bumps 22 and 34. Accordingly, when the paste bump 22 formed on the first insulating layer 24 and the paste bump 34 formed on the second insulating layer 32 are inserted into the holes, the end portions having different widths are in contact with each other. Hence, the widths of the paste bumps 22 and 34 provided on the metal core package substrate may decrease toward the inside from the both end portions. For example, the paste bumps 22 and 34 may have a shape of a sandglass.

Accordingly, the metal core package substrate includes the metal core layers therein, thereby suppressing a thermal expansion behavior and preventing distortion such as bending.

In the present invention, it is possible to shorten a process time and save process cost through process simplification by allowing the paste bumps to pierce between the metal cores and serve as interlayer electrical connection by positioning the copper foil layers with the paste bumps piercing to the insulation layers on both sides of each metal core to be opposed to each other and pressing the copper foil layers.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method for manufacturing a metal core package substrate, comprising:
forming a plurality of holes in a metal core;
forming a plurality of paste bumps piercing into insulation layers on each of a first copper foil layer and a second copper foil layer;
positioning the first and second copper foil layers at positions corresponding to the holes of the metal core so that the paste bumps are opposed to each other around the metal core;
allowing each paste bump to pierce into the holes of the metal core by pressing the first copper foil layer and the second copper foil layers; and
forming inner circuits in the metal core pierced with the paste bumps.

2. A method for manufacturing a metal core package substrate, comprising:
forming a plurality of holes in a metal core;
forming a plurality of paste bumps piercing into an insulation layer on a first copper foil layer;
forming the insulation layer on a second copper foil layer;
positioning the first copper foil layer so that the paste bumps are positioned at positions corresponding to the holes of the metal core on the metal core and positioning the insulation layer of the second copper foil layer to face the metal core;
allowing each paste bump to pierce into the holes of the metal core by pressing the first copper foil layer and the second copper foil layer; and
forming inner circuits in the metal core pierced with the paste bumps.

3. The method as recited in claim 1 or 2, further comprising:
forming multi-layered outer circuit layers in an upper part and a lower part of the inner circuit by a build-up method.

4. The method as recited in claim 3, wherein widths and heights of the paste bumps have 300 μm.

5. The method as recited in claim 3, wherein the insulation layer is made of any one selected from build-up materials such as epoxy based insulating materials, an ABF (Ajinomoto Build-up Film), an LCP (Liquid Crystal Polymer), PTFE (PolyTetraFluoroEthylene), PI (PolyImide), and PEEK (PolyEtherEtherKeton).

6. The method as recited in claim 3, wherein a thickness of each copper foil layer is in the range of 1 to 35 μm.

7. The method as recited in claim 3, wherein a process of forming solder paste on the outer circuits is further performed in order to protect the circuit.

8. The method as recited in claim 7, wherein a surface treatment process is further performed after the solder paste forming process.

9. The method as recited in claim 8, wherein a process of forming a solder bump in a mounting portion is further performed after the surface treatment process.

10. The method as recited in claim 9, wherein the surface treatment process is performed by any one selected from an electro gold plating method, an OSP (Organic Solderability Preservative) method, an immersion tin plating method, an ENIG (Electroless Nickel Immersion Gold) method, an ENEPIG (Electroless Nickel Electroless Palladium Immersion Gold) method, and the like.

11. A metal core package substrate, comprising:
a metal core layer including a plurality of holes penetrating a body;
a paste bump penetrating the holes;
first and second insulating layers exposing both end portions of the paste bump and disposed on both surface of the metal core layer; and
circuits disposed on outer surfaces of the first and second insulating layers, and electrically connected to each other.

12. The metal core package substrate as recited in claim 11, wherein the both end portions of the paste bump have different areas.

13. The metal core package substrate as recited in claim 11, wherein widths of the both end portions of the paste bump decrease toward the inside.

14. The metal core package substrate as recited in claim 11, wherein the metal core layer includes a metal core and plating layers disposed on both surfaces of the metal core.
